(19) United States
(12) Patent Application Publication
(10) Pub. No.: US 2021/0336374 A1
(43) Pub. Date: Oct. 28, 2021

(54) Impermeable electrical connector

(71) Applicant: Antoine Yazgi, Flossmoor, IL (US)

(72) Inventor: Antoine Yazgi, Flossmoor, IL (US)

(21) Appl. No.: 16/974,349

(22) Filed: Feb. 4, 2020

(51) Int. Cl. H01R 13/52

(52) U.S. Cl. CPC H01R 13/52

(57) ABSTRACT

The impermeable electrical connector is a quick connector device whose object is to quickly connect electrical terminals while preventing any water, moisture, or gas from entering or contaminating it.

### BACKGROUND OF THE INVENTION

This inventor saw the necessity for the use of a completely safe electrical connector as products marketed for the same purpose are of unacceptable performance and proceeded to develop a similar suitable item with a different concept.

### BRIEF SUMMARY OF THE INVENTION

The connector is a device which allows an electrical source to be safely extended by means of a water, moisture, or gas tight connector.

### BRIEF DESCRIPTION OF DRAWINGS

FIG. 1, Identical half of assembled unit shown prior to cap being screwed down for compression and constriction of seal.

FIG. 2, Screw down cap in two halves showing locking tabs to maintain integrity of cap.

FIG. 3, Piston shown in two halves used to compress and constrict with inner tabs to maintain vertical movement and prevent twisting of seal.

FIG. 4, Restrictor component in two halves with seals in between to prevent seepage.

FIG. 5, Rubber seal to be compressed and constricted with slit to allow cable to be totally encircled.

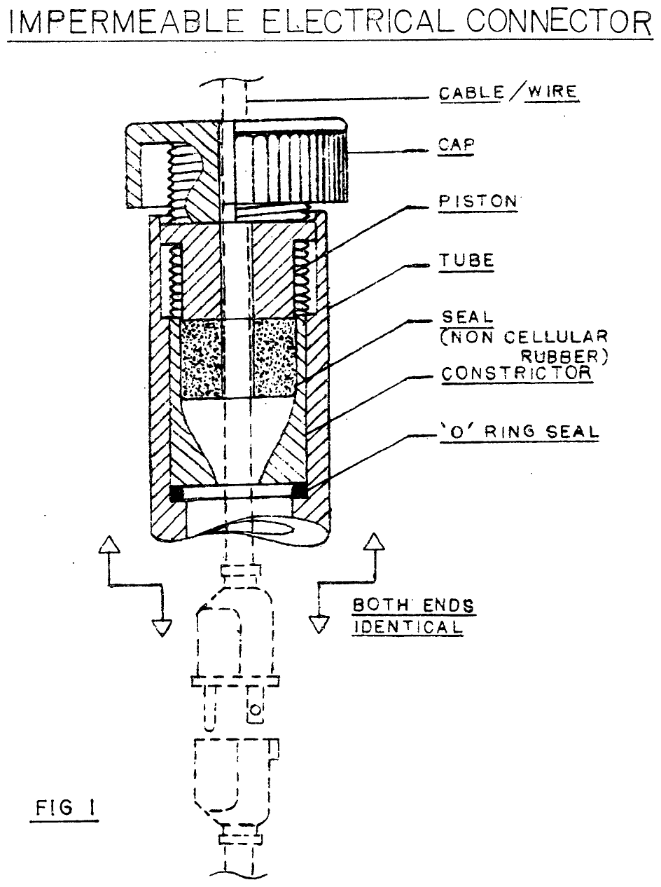

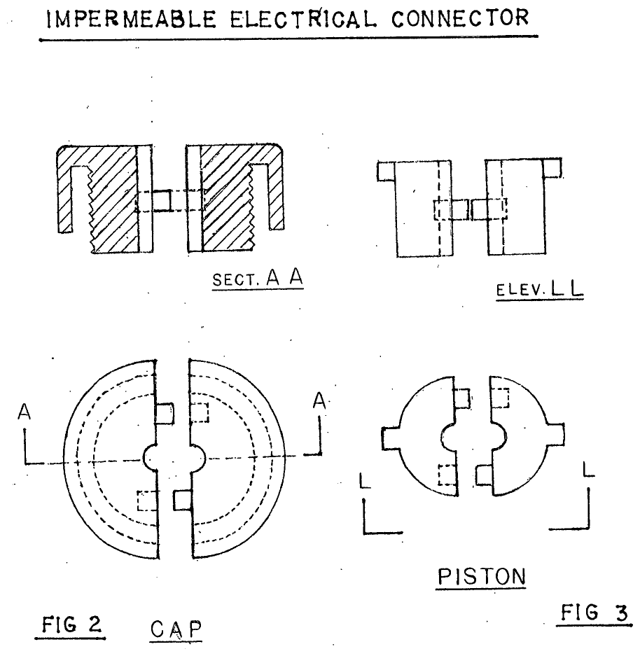

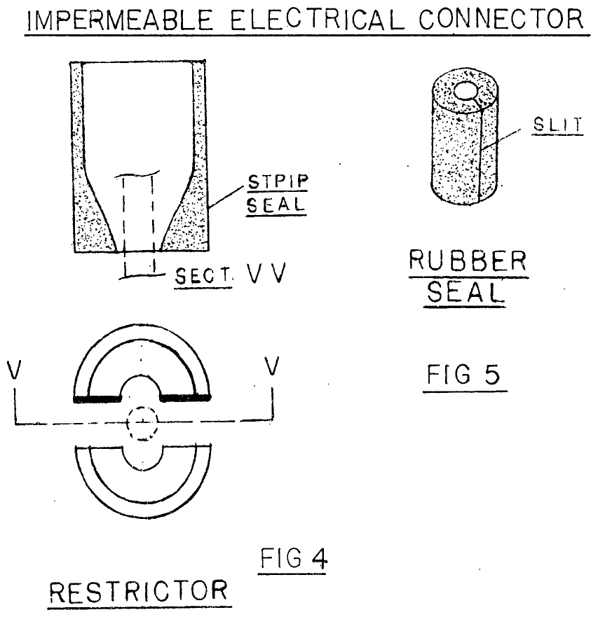

### DETAILED DESCRIPTION OF THE INVENTION

The connector is a device made of die cast plastic or similarly suitable material with rubber components performing the function of sealing. It is operated by compressing and constricting a rubber seal around a cable by the action of screwing down a cap at each end of the unit. The unit is submersible. Applications include industry, construction, military, commercial, landscaping, hospital, residential, etc.

1. The claimed invention represents a quick electrical connector enabling the extension of an electrical source by means of connection plug and socket terminals in which the item maintains a connection impermeable to water, moisture, and gas.
